(19) United States
(12) Patent Application Publication
(10) Pub. No.: US 2009/0106532 A1
(43) Pub. Date: Apr. 23, 2009

(54) RAPID CREATION AND CONFIGURATION OF MICROCONTROLLER PRODUCTS WITH CONFIGURABLE LOGIC DEVICES

(75) Inventors: Ata R. Khan, Saratoga, CA (US); Rob Cosaro, San Jose, CA (US); Joe Yu, Palo Alto, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/294,223

(22) PCT Filed: Mar. 21, 2007
(86) PCT No.: PCT/IB2007/050999

§ 371 Date: Sep. 23, 2008

Related U.S. Application Data
(60) Provisional application No. 60/785,681, filed on Mar. 24, 2006.

(51) Int. Cl. G06F 15/76; G06F 9/02

(52) U.S. Cl. 712/36; 712/E09.002

(57) ABSTRACT

Methods and apparatus suitable for rapid creation and configuration of microcontroller products, which include a microcontroller or similar computational resource, and configurable logic devices are described. Various embodiments of the present invention allow development of new microcontroller-based products and product families in a rapid and cost-effective manner, thereby enabling early entry of such products into the marketplace. An existing microcontroller block and existing configurable logic devices are combined to form a unique product, wherein the microcontroller block is operable to configure the configurable logic devices to form the desired unique hardware characteristics of the microcontroller-based product. The microcontroller block configures the configurable logic devices when the product is reset, and/or when a power-up condition is recognized.

The present invention relates generally to methods and apparatus for rapid and cost-effective development of microcontrollers or microcontroller-based products that include a microcontroller core coupled to configurable logic devices.

Advances in semiconductor manufacturing technologies have resulted in the ability to include millions of circuit elements, such as transistors, onto a single integrated circuit. Given such capabilities, a number of manufacturers developed complex designs for programmable products such as microcontrollers and microprocessors. Such programmable devices allow a wide variety of customer products to be developed, however many products still require differences in, for example, their physical interfaces to the external world. Consequently, additional design, development, and verification work are needed to produce these products even though much of their internal hardware resources remain the same.

In a competitive marketplace, the ability to quickly develop and deliver a product has become an important factor in the economic success of such products.

What is needed are methods and apparatus for providing rapid creation and configuration of products which include at least a computational resource, such as a microcontroller.

Briefly, methods and apparatus suitable for rapid creation and configuration of microcontroller products, which include a microcontroller or similar computational resource, and configurable logic devices are described. Various embodiments of the present invention allow development of new microcontroller-based products and product families in a rapid and cost-effective manner, thereby enabling early entry of such products into the marketplace.

In a further aspect of the present invention, an existing microcontroller block and existing configurable logic devices are combined to form a unique product, wherein the microcontroller block is operable to configure the configurable logic devices to form the desired unique hardware characteristics of the microcontroller-based product.

In a still further aspect of the present invention, the microcontroller block configures the configurable logic devices when the product is reset, and/or when a power-up condition is recognized.

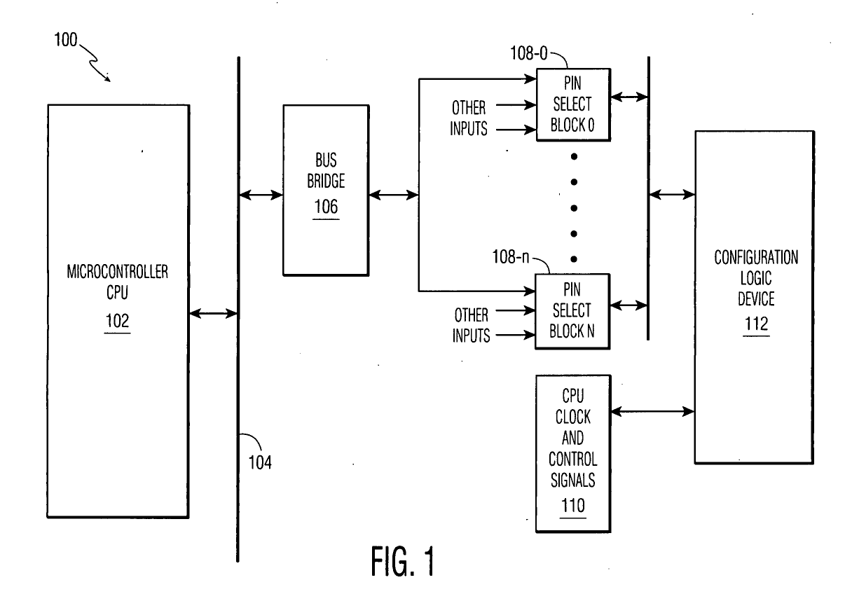

FIG. 1 is a block diagram of an illustrative microcontroller-based product in accordance with the present invention.

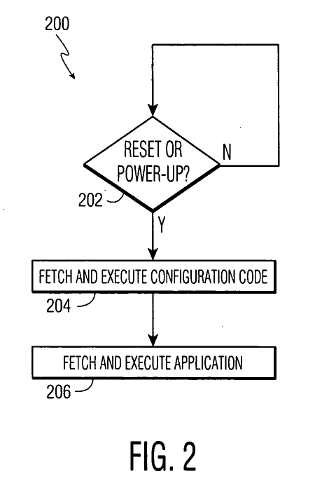

FIG. 2 is a flow diagram illustrating the operation of a microcontroller to determine whether to configure the configurable logic devices, configuring the configurable logic devices and executing a customer specific application program.

Generally, the present invention relates to methods and apparatus for combining an existing design for a computational resource, with an existing design for a configurable logic block, and having the computational resource execute software to configure the configurable logic block, and then execute an application program.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

The terms microcomputer, microcontroller, embedded controller, embedded processor and similar variants are sometimes used interchangeably in this field and are generally meant to include digital data processing circuit blocks suitable for integration into larger integrated circuits, or complete devices such as those exemplified by the well-known 8051 family of microcontrollers. It is noted that the present invention is not limited to any particular instruction set architecture or circuit level implementation.

A computer, whether a large or small system, or a microprocessor or microcontroller is often referred to in this field as a machine. For example, the “state of the machine” generally refers to the logical state of the computer as manifested by the state of substantially all the storage bits therein. Additionally, both complete computer systems and CPUs are sometimes referred to broadly as programmed data processors. The term, programmed data processor, is used herein to encompass all manner of computing, or data processing, elements such as microprocessors, microcomputers, and any functionally equivalent device or system.

The terms integrated circuit, IC, chip, die, semiconductor device, monolithic integrated circuit, microelectronic device, and similar variants may be used interchangeably herein, and microelectronic device is considered to be the broadest term, encompassing the others. With respect to these microelectronic devices, signals are coupled between them and other circuit elements, including but not limited to other microelectronic devices, via physical, electrically conductive connections. The point of connection is sometimes referred to as an input, output, input/output (I/O), terminal, line, pin, pad, port, interface, or similar variants and combinations. Unless specifically noted in the context of use, these are considered equivalent terms for the purpose of this disclosure. The present invention is applicable to all the above as they are generally understood in the field.

As noted above, microcontrollers are general-purpose system building blocks used by customers in virtually every market segment. This is a large and growing market that is presently estimated to be in the billions of dollars. However, it recognized that the microcontroller business, which includes but is not limited to microcontroller integrated circuits and microcontroller-based products, is a highly competitive business, and that customers often make decisions based on the cost and/or the amount of time required to design and deliver a product in accordance with their specifications.

The needs of each customer, in terms of the functional and electrical specifications of their particular microcontroller or microcontroller-based products, are different. It will be recognized by those skilled in the art and having the benefit of this disclosure that it is time-consuming, and often prohibitively expensive, to develop microcontrollers or microcontroller-based products, for every different customer need (literally thousands). Furthermore, because economies of scale may be difficult to obtain, there is a relatively high risk of low sales volume for a particular microcontroller or microcontroller-based product leading to poor or negative return on investment in a particular design. Various embodiments of the present invention provide a low-cost way of creating new products rapidly, and optimizing only those that are high-volume sellers.

Customers of the designers and/or manufacturers of microcontrollers, or microcontroller-based products, commonly operate in a business environment in which there is significant pressures to get their products to market quickly. In view of the foregoing, it is important for designers and/or manufacturers of microcontrollers or microcontroller-based products to respond quickly to customer needs and their time-constraints in order to win their business.

With respect to the customer needs, i.e., their functional and electrical specifications, it is noted that most of the differences between these customer specifications are typically based around varying peripheral function requirements rather than CPU architecture or memory sizes (memory range needs can be accommodated relatively easily).

In order to provide rapid and cost-effective design and manufacturing in accordance with a customer's specifications, various embodiments of the present invention provide a microcontroller that is coupled to configurable circuitry in such an architecturally integrated manner that the two look like an integral part of the microcontroller, and such that the microcontroller performs the necessary configuration, connection, and communication functions with this configurable circuitry. Such configurable circuitry may be in the form of a configurable logic device (CLD). In accordance with the present invention, integrating operational details of a CLD, or similar functional block, spares a user from complexity and reduces vendor support costs.

As indicated above, various embodiments of the present invention provide a combination of one or more available, or pre-existing, microcontrollers with one or more available, or pre-existing, configurable logic devices. In such combinations the configurable logic devices are typically functionally configured by the manufacturer to meet the customer's needs (i.e., specifications); and seamlessly connected, physically and logically, to the microcontroller to appear as an integrated unit. It will be appreciated that although the microcontroller and configurable logic device may be integrated on a single die, they may each reside on separate die. Similarly, a microcontroller die and a configurable logic device die may be packaged in a single package, or they may be packaged in separate packages with external interconnections provided between those packages.

In one illustrative embodiment of the present invention, at least one configuration operation is carried out upon the configurable logic device at power-up and when reset, so that the configurable logic device performs the desired function. In this illustrative embodiment, the at least one configuration operation is accomplished through configuration software that is resident on the microcontroller. Such configuration software typically includes the configuration values as well as the configuring program. Those skilled in the art and having the benefit of this disclosure will appreciate that although this illustrative embodiment has the configuration software resident on the microcontroller, it is within the scope of the present invention to have the configuration software in memory external to the microcontroller, as long as the microcontroller is able to execute the configuration software.

The illustrative embodiment provides a physical and logical connection between the microcontroller and the configurable logic device so as to allow for flow of control and data information between the two, and such an embodiment typically includes security measures with respect to the control and data signals that pass therebetween.

In a further aspect of the present invention, the illustrative embodiment has the microcontroller manage power-up and reset functionality of the configurable logic device so as to transition between, and control different operational and power management states of the product.

Referring to FIG. 1, an illustrative microcontroller-based product 100 in accordance with the present invention is shown and described. A microcontroller block 102 is coupled to a bus 104. In turn, bus 104 is coupled to a bus bridge 106. Bus bridge 106 is coupled to a plurality of pin select blocks 108-0 through 108-n. A configurable logic device 112 is coupled to pin select blocks 108-0 through 108-n, and to a clock and control signal generating block 110. It is noted that microcontroller block 102 is a computational resource that has been previously designed and verified. Microcontroller 102 is not limited to a particular instruction set architecture, data path width, number of registers, and so on.

Microcontroller 102 may be implemented with all the other shown components on a single chip, however, this is not requirement of the present invention. More particularly, the customer specific interface represented by pin select blocks 108-0 through 108-n provides a unique hardware characteristic for the microcontroller-based product 100, without having to design either the microcontroller or configurable logic device from scratch. In this way, considerable time and effort are saved by using pre-existing circuit blocks for the microcontroller and configurable logic devices, while still producing a unique hardware interface.

Bus bridge 106 may be any suitable circuitry for communicating the results of instruction execution by microcontroller 102 to pin select blocks 108-0 through 108-n.

Those skilled in the art and having the benefit of this disclosure will appreciate that pin select blocks 108-0 through 108-n represent the customer specific interface of an illustrative embodiment, and will further appreciate that the characteristics of such an interface may be tailored to any particular customer specification by executing a correspondingly different set of configuration instructions by microcontroller 102.

In operation, microcontroller 102 executes stored instructions that cause it to generate the signals which configure configurable logic device 112 to perform the desired circuit functions which in turn produce the unique customer interface. In this context, the execution of instructions by the microcontroller may sometimes be referred to by similar expressions such as running, or executing, code, or firmware, or software.

Subsequent to executing the configuration code, microcontroller 102 executes a customer specific application program.

Referring to FIG. 2, a process 200 is shown in which at a step 202 a determination is made as whether a reset or power-up condition has occurred. If a reset or power-up condition has occurred then at a step 204 the configuration code is fetched and executed. At the completion of the configuration operation, microcontroller 102 fetches and executes a customer specific application program 206.

Various embodiments of the present invention find application in a wide variety of products. Examples of products which could be rapidly realized in accordance with the present invention include, but are not limited to, MCUs with one or more of the following: CAN interface, Industrial 9-bit UARTs and USARTs, Encryption Unit High-speed Serial interfaces (e.g., SERDES, PCI Express, Ethernet), Consumer Serial interfaces (e.g., 12C, 12S, USB, PCM, SPI), Audio and Video Codecs, Custom Signal Processing Blocks, Customer-specified Logic, Memory interfaces (e.g., NAND Flash, DDR, SDRAM), Memory Card interfaces (e.g., SD, CF, Memory Stick), Smart Cards, Wireless Media Access Controllers, CPU Bus Expansion, Re-configurable co-processors, and Display controllers (e.g., LCD Controllers).

Various embodiments of the present invention include methods and apparatus for providing the rapid creation and configuration of microcontroller-based products. A microcontroller, or similar computational resource is coupled to configurable logic, and is responsible for. among other things, configuring the configurable logic devices. The user transparent configuration operation allows the product to operate as if it were a microcontroller with a custom designed interface.

A number of advantages are provided by embodiments of the present invention. For example, customer needs can be met very rapidly with the product creation cycle time being reduced to essentially the configurable logic device configuration and product verification time.

Another advantage is that since proven components (i.e., pre-existing microcontroller and configurable logic device designs) are used, product creation risk is considerably reduced.

Another advantage is that knowledge-based product optimization strategies can be employed. For example, high-volume selling derivatives can be optimized as a true one-chip design; and chip development costs need not be incurred if sales volumes are low.

Another advantage is that many different configurable logic device components are available on the market and optimal ones can be chosen depending on customer needs. In other words, PLDs, FPGAs, CPLDs, FPSCs, pSOCs, are all examples of configurable logic devices which are suitable for use in embodiments of the present invention. All of these devices have logic structures that have customer programmable functionality.

Another advantage is that system cost savings accrue from integrating the configurable logic device configuration patterns and software on the microcontroller. This could otherwise require an external memory chip as well as an external configuring device or communication link. In some embodiments of the present invention, the configuration patterns stored with the microcontroller are compressed to further reduce memory requirements.

A still further advantage is that bug fixes and enhancements can be incorporated into the configurable logic device via the configuration software executed by the microcontroller; this can be done in the field and/or in-system.

It is to be understood that the present invention is not limited to the embodiments described above, but encompasses any and all embodiments within the scope of the subjoined Claims and their equivalents.

1. A microcontroller-based product, comprising:
a microcontroller;
a first set of instructions stored in a first memory area coupled to the microcontroller;
a second set of instructions stored in a second memory area coupled to the microcontroller;
a first set of terminals coupled to the microcontroller;
a first configurable logic block coupled to the first set of terminals, and further coupled to the microcontroller;
wherein the microcontroller is operable to execute the first set of instructions to configure the first configurable logic block, and further operable to execute the set of instructions.

2. The microcontroller-based product of claim 1, wherein the terminals comprise pin select logic.

3. The microcontroller-based product of claim 2, wherein the microcontroller is coupled to the first set of terminals through a bus bridge that is adapted to transfer signals resulting from the execution of the first set of instructions to the pin select logic.

4. The microcontroller-based product of claim 1, wherein the second set of instructions comprises a customer-specific application program.

5. The microcontroller-based product of claim 1, wherein the microcontroller is adapted to determine whether a reset has occurred.

6. The microcontroller-based product of claim 5, wherein the microcontroller is operable to execute the first set of instructions if a reset has occurred.

7. The microcontroller-based product of claim 1, wherein the microcontroller is adapted to determine whether a power-up condition has occurred.

8. The microcontroller-based product of claim 5, wherein the microcontroller is operable to execute the first set of instructions if a power-up condition has occurred.

9. A method of operating a microcontroller-based product, comprising:
determining whether a reset has occurred;
executing, if a reset has occurred, a first set of instructions;
determining whether a power-up condition has occurred;
executing, if a power-up condition has occurred, the first set of instructions;
executing a second set of instructions subsequent to executing the first set of instructions;
wherein executing the first set of instructions causes a configurable logic device to be configured, and wherein executing the second set of instructions causes a customer-specific application program to be run.

10. The method of claim 9, wherein configuring the configurable logic device in accordance with the first set of instruction provides a first set of hardware characteristics of the microcontroller-based product.

11. The method of claim 10, wherein the first set of instructions are replaced with a third set of instructions.

12. The method of claim 11, wherein executing the third set of instructions causes the configurable logic device to be configured so as to provide a second set of hardware characteristics of the microcontroller-based product.

13. The method of claim 12, wherein the microcontroller-based product includes a microcontroller in a first package and a configurable logic device in a second package.

14. The method of claim 12, wherein the microcontroller-based product includes a microcontroller in a first package and a configurable logic device in the first package.
